(19) United States
(12) Patent Application Publication
(10) Pub. No.: US 2019/0337320 A1
(43) Pub. Date: Nov. 7, 2019

(54) SHEET WITH SPRING STRIP

(71) Applicant: CCL Label, Inc., Framingham, MA (US)

(72) Inventors: Sriram Venkatasanthanam, Chino Hills, CA (US); Jay Sato, Mission Viejo, CA (US)

(21) Appl. No.: 16/400,064

(22) Filed: May 1, 2019

Related U.S. Application Data
(60) Provisional application No. 62/665,016, filed on May 1, 2018.

(51) Int. Cl. B42D 1/00; B42D 1/10

(52) U.S. Cl. CPC B42D 1/004; B42D 1/006; B42D 1/10; B42D 1/009; B42D 1/007

(57) ABSTRACT

A printable sheet assembly and method provide for feeding cardstock sheets through a printer. The printable sheet assembly may include a focal line formed in a body of the sheet. An adhesive adheres a spring strip to the body. The spring strip overlays the focal line. The spring strip is a rigid material that acts as a spring for the focal line

### CROSS REFERENCE TO RELATED APPLICATIONS

This application claims priority to and the benefit of U.S. Provisional Patent Application No. 62/665,016 filed on May 1, 2018 and titled, “SHEET WITH SPRING STRIP” which is incorporated herein in its entirety.

### FIELD OF INVENTION

The present disclosure generally relates to a sheet assembly and method of making a sheet assembly that is to be processed through a printer to print indicia thereon, and more particularly, the disclosure relates to a sheet assembly with a spring strip that improve printer processing of the sheet.

### BACKGROUND

Sheets for printing have been proposed to meet the requirements of a wide variety of applications. Some applications include card products such as badge inserts, business cards, tent cards, and nametags. Card products may include perforations to allow such products to be folded, torn, or the like.

Card products or sheets may have a single layer without adhesives or a liner. These sheets are typically thicker than ordinary printer paper. The sheets may also be stiffer as the card products may be placed into a sleeve or display.

However, problems arise when a user processes cardstock through a printer, such as an inkjet printer, desktop printer, or laser printer. Many printers are configured to receive a cardstock or other sheet and process it through at least one, but usually more than one, rotary mechanisms during the printing process. The thickness or stiffness of cardstock may cause the printer to print with gross off-registration. In some instances, the card products may bend or fold in certain areas as it goes through a printer feed path which may causes gross off-registration. This may cause ink to shift or other printing errors. In certain popular inkjet printers, gross off-registration of the print has been a common problem when running sheets of cards or sheets of labels that have fold lines in certain key areas. The sheet feeding sequence through these printers is such that a fold in the sheet can cause inconsistent transport of subsequent sheets through the printer which leads to off-registration of the print.

Therefore, there is a need for a printable sheet assembly for cardstock or label sheets configured to reduce inconsistent processing through a printer. There is also a need for an improved method of feeding a cardstock sheet through a printer to accurately apply ink or indicia thereon without unduly altering the alignment or registration of the print, while making perforations more robust and maintaining ability for separation and a smooth edge.

### SUMMARY

The present system leverages the advantages of a printable sheet assembly with a spring strip. The printable sheet assembly comprises a cardstock comprising a first focal line formed therein and a first spring strip comprising a resilient material and disposed over the first focal line, wherein the first spring strip is at least partially adhered to the cardstock. The cardstock comprises a first side and a second side, wherein the first side operatively receives indicia and wherein the second side operatively receives the first spring strip. The cardstock comprises a leading edge and a trailing edge, wherein the first spring strip is adhered to the cardstock at a leading-edge side of the first focal line and is not adhered to the cardstock at the trailing-edge side of the first focal line. The first spring strip freely overlays the first focal line. In an aspect, the printable sheet comprising a second focal line and second spring strip positioned over the second focal line. The second spring strip freely overlays the second focal line. In another aspect, the cardstock comprises at least one of a nametag, card, label, or display product formed therein. It is noted that the spring strip may comprise a polymer.

A printable sheet assembly comprises a sheet body or stock material comprising a first side and a second side, at least one focal line formed in the stock material, wherein the at least one focal line is operatively creaseable, and at least one spring strip disposed on the second side of the stock material and overlaying the at least one focal line, wherein the at least one spring strip operatively acts as a spring for the at least one focal line during a printing operation.

Further described is a method of making a printable sheet assembly. The method may comprise providing cardstock material, forming focal lines in the cardstock material, and adhering a resilient strip to the cardstock such that it overlays at least one of the focal lines. The resilient strip passes freely over the at least one focal line.

Specific reference is made to the appended claims, drawings, and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### BRIEF DESCRIPTION OF THE DRAWINGS

Operation of the disclosure may be better understood by reference to the following detailed description taken in connection with the following illustrations, wherein:

FIG. 1 is a top, plan view of an embodiment of a printable sheet assembly with a focal fold line and a number of card products formed in the assembly in accordance with various disclosed embodiments;

FIG. 2 is a back, plan view of the printable sheet assembly of FIG. 1 with a spring strip line in accordance with various disclosed embodiments;

FIG. 3 is a top, plan view of an embodiment of a printable sheet assembly with a focal fold line in accordance with various disclosed embodiments;

FIG. 4 is a back, plan view of the printable sheet assembly of FIG. 3 with a spring strip in accordance with various disclosed embodiments;

FIG. 5 is a top, plan view of an embodiment of a printable sheet assembly with a plurality of focal fold lines in accordance with various disclosed embodiments;

FIG. 6 is a back, plan view of the printable sheet assembly of FIG. 5 with a plurality of spring strips in accordance with various disclosed embodiments;

FIG. 7 is a method of forming a printable sheet assembly in accordance with various disclosed embodiments; and

FIG. 8 illustrates test data summarizing various embodiments of printable sheet assemblies being processed through a printer device.

### DETAILED DESCRIPTION

Reference will now be made in detail to embodiments of the present disclosure, examples of which are illustrated in the accompanying drawings. It is to be understood that other embodiments may be utilized and structural and functional changes may be made without departing from the respective scope of the disclosure. Moreover, features of the various embodiments may be combined or altered without departing from the scope of the disclosure. As such, the following description is presented by way of illustration only and should not limit in any way the various alternatives and modifications that may be made to the illustrated embodiments and still be within the spirit and scope of the disclosure.

A printable sheet assembly (e.g., label sheet, nametag sheet, card product etc.) may comprise a cardstock sheet, printable papers, printable films, non-woven materials, polyolefin materials, and laminates thereof. The sheet face stock may be a single layer or may include different layers, such as a liner, an adhesive, and a face stock layer. It is noted that the different layers may comprise different materials and have different properties. For instance, a first layer may comprise a cardstock and a second layer may comprise a less stiff or less thick layer.

Described printable sheet assemblies may have various sizes, such as A3, A4, 8½ inches by 11 inches, 8½ inches by 14 inches, 11 inches by 17 inches, legal size or any other size, including, without limitation smaller sizes. Generally, a sheet assembly is operatively sized to be fed through a desktop printer and/or copier (such as by way of a non-limiting example an ink jet and/or laser printer). For instance, a sheet assembly may be fed through a horizontal-feed inkjet printer.

In certain inkjet printers, gross off-registration of the print on cardstock having perforations can occur and can be a problem. The sheet feeding sequence through these printers is such that a fold in the sheet can cause a retardation of the transport of the sheet, which in turn leads to off-registration of the print. As such, consumers may be left with sheets having errors on the indicia printed thereon. This may result in a need to reprint the sheet. Exemplary printers include horizontal-feed printers. Some printers available on the market are the HP ENVY 4500, HP PRO 8000 Wireless, HP PHOTOSMART 5520, CANON PIXMA MG3520, and CANON PIXMA MX922. The solutions should work for all similarly configured printers (i.e. older or newer models of the same product lines using the same sheet transport path and mechanism).

Described embodiments include printable sheet assemblies comprising a strip of resilient material positioned over focal lines of a sheet assembly of printable cards or labels. The focal lines could be perforation lines or could be fold lines. The strip may be adhered to a portion of the sheet assembly on the focal fold line adjacent the leading-edge-side of the sheet assembly. In an aspect, a small portion of the strip may freely overlay the fold line. The strip acts like a spring to keep the fold line from creasing, tearing, or becoming otherwise damaged during printing resulting in improved print registration. The strip may increase the likelihood of proper print registration, leading to increased consumer satisfaction. It is noted that the strip may be removed by a user or may be left on the product after printing.

In some embodiments, the strips may be positioned over focal perforation lines of a sheet assembly. This may allow for improved print registration and increased flexibility of perforations, while maintaining ease of separation and a smooth edge.

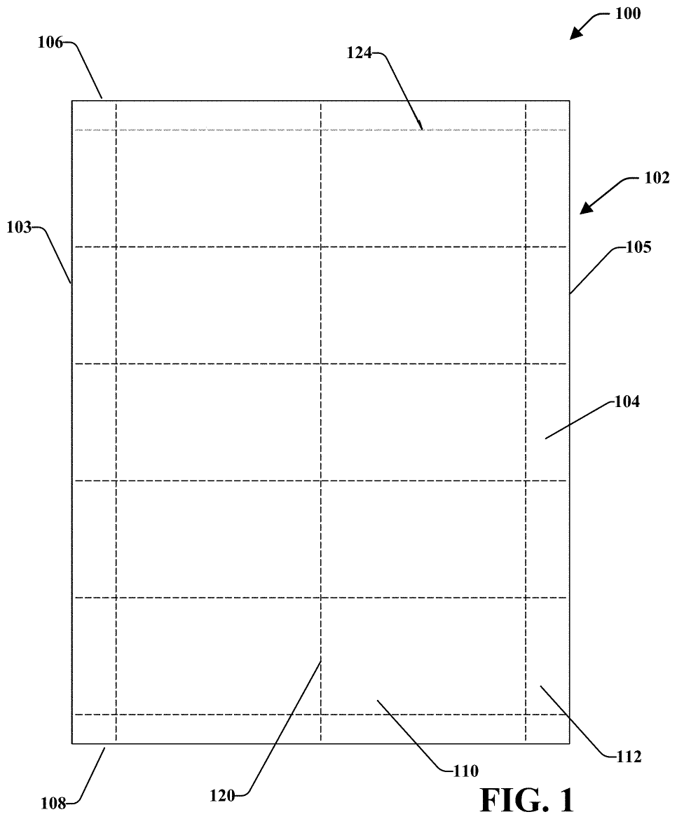

As shown in FIG. 1, a printable sheet assembly 100 is disclosed and may be of any appropriate size and configuration as described herein. For instance, the printable sheet assembly 100 may be of an A4 size and may be formed of cardstock. The printable sheet assembly 100 may be made of any appropriate materials and colors or indicia and this disclosure is not limited in this regard.

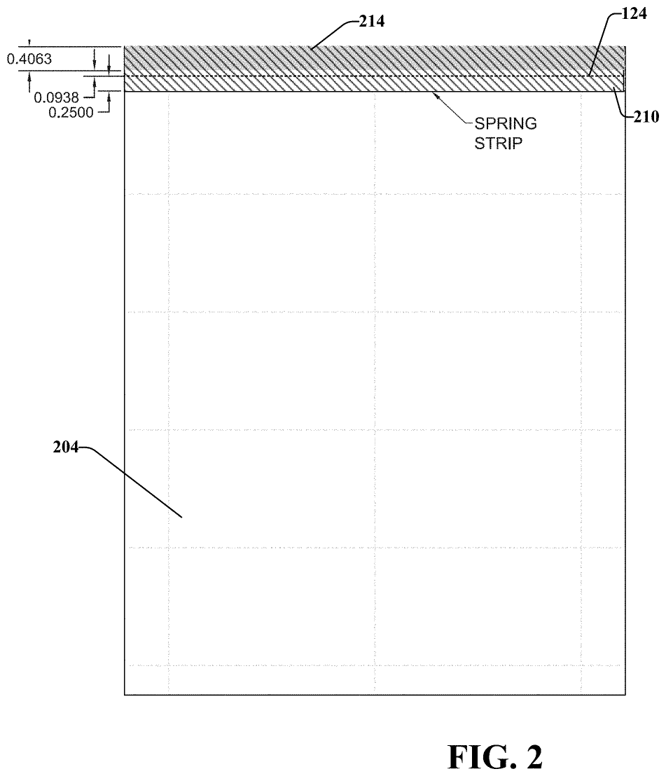

Printable sheet assembly 100 may include a body 102 comprising a first side 104 and a second side 204, as shown in FIG. 2. The body 102 may include a first or leading edge 106 and a second or trailing edge 108. First edge 106 and second edge 108 may comprise horizontal edges of the sheet assembly 100. In some embodiments, first edge 106 may be referred to as a top edge and second edge 108 may be referred to as a bottom edge. The sheet assembly 100 may also include side edges 103, 105 along the left side and right side of FIG. 1. As an example, the first edge 106 may be a leading edge that is fed into a printer. The printer may print onto the sheet assembly 100 and may continue to feed the sheet assembly 100 through the printer until second edge 108 exits the printer. In some embodiments, first side 102 may be placed face down in a feed tray of a horizontal feed printer. The printer rollers will process the sheet 100 such that the sheet 102 is output with first side 102 face up.

Sheet 100 may include one or more print areas 110 or products formed thereon or therein. For instance, print areas 110 may comprise nametags, cards, or other products that may operatively receive indicia during a printing process. While sheet 100 is shown as comprising ten print areas 110, embodiments may comprise i print areas 110 (where i is a number). In another aspect, the print areas 110 may comprise various sizes and shapes. Sheet 100 may include a matrix or margins 112.

Fold lines 120 may be formed in sheet 100. Fold lines 120 may separate the print areas 110 or margins 112. In an aspect, some or all of the fold lines 120 may comprise perforations, weakened areas, or the like. Moreover, embodiments may include j fold lines 120 (where j is a number). The fold lines 120 may be horizontal, vertical, diagonal, or the like. In an example, the fold lines 120 may be arranged in a matrix such that the sheet 100 comprises a number of card products.

As some traditional sheet assemblies are passed or processed through a printer, the fold lines 120 may crease, deform, break, or otherwise be manipulated. This may cause gross off-registration of print projects.

Described embodiments may include a spring strip 210 placed on or over a focal line 124 proximal the first edge 106. It is noted that focal line 124 may be a fold line or a perforation line having a spring strip may be referred to as a focal line for simplicity of explanation. The spring strip 210 may comprise a resilient material that may act as a spring or reinforcement of the focal line 124. The resilient material may include plastics, paper, metals (e.g., aluminum, etc.), or other materials. In at least one embodiment, the spring strip 210 comprises a polymer having a level of elasticity and rigidity to provide a spring support to the focal line 124 as it is processed through rollers of a printer.

The spring strip 210 may be attached to the second side 204 of sheet 100 via an adhesive 214. In an aspect, the adhesive may be disposed between a portion of the second side 204 and a portion of the sprint strip 210. In an embodiment, the sprint strip 210 is adhered to the portion of the sheet 100 on the leading or first edge 106 side of the focal line 124. A portion of the spring strip 210 may freely overlay the focal line 124. In some embodiments, however, the spring strip 210 is adhered over the focal line 124. Moreover, the spring strip 210 may be releasable or non-releasable.

In at least one example, sheet 100 may comprise an 8.5 inch by 11 inch body. The adhesive 214 may be disposed from the first edge 106 to about 0.4 (e.g., 0.4063, etc.) inches away from the first edge. The adhesive 214 may extend from the side edge 103 to side edge 105 and also may extend continuously along the first edge 106. The adhesive may have a width that terminates between the focal line 124 and the first edge 106. In an example, the adhesive 214 terminates about 0.09 (e.g., 0.0938 in an embodiment) inches away from the focal line 124 towards the first edge 106. The spring strip 210 extends the width of the body 102 from the side edge 103 to side edge 105 and extends from the first edge 106 to about 0.25 inches passed the focal line 124 away from the first edge 106. As can be seen, the adhesive is disposed such that only a portion of the spring strip 210 is adhered to the second side 204 of the body 102. This allows the spring strip 210 to be free of adhesive over the focal line 124 and for the spring strip 210 to extend a distance passed the focal line. It is noted that the above measurements are exemplary. For instance, the adhesive may be applied over different areas, spring strip 210 may comprise different dimensions, and focal line 124 may be disposed at different locations.

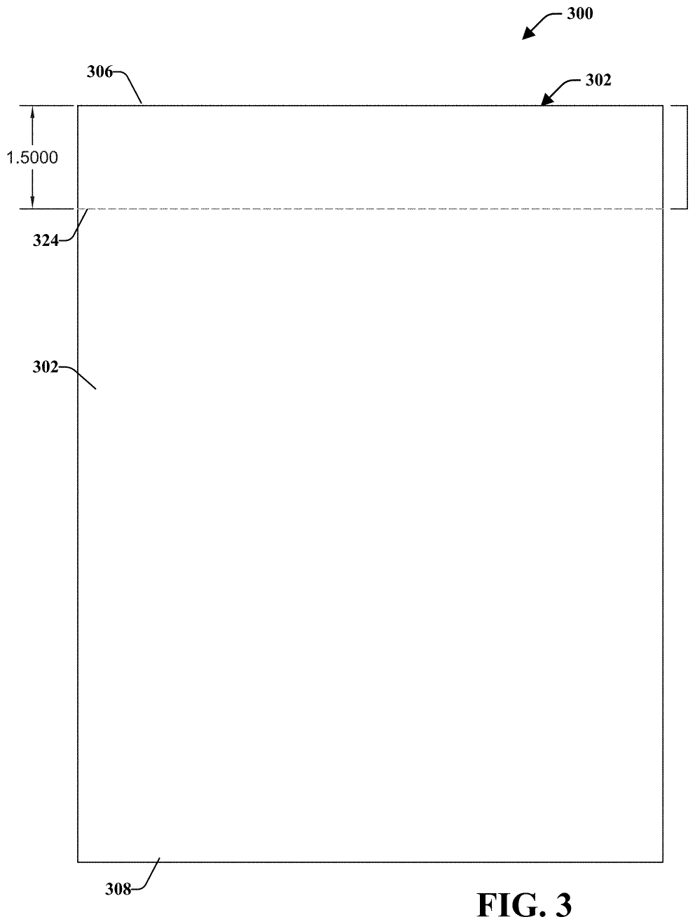

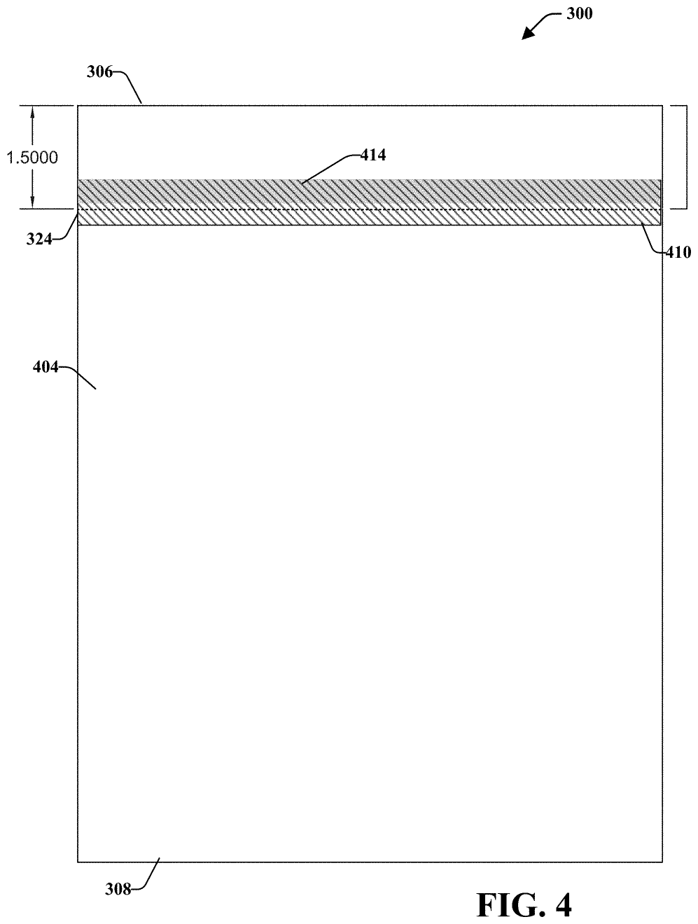

For instance, FIGS. 3-4 illustrates a sheet assembly 300 comprising body 302 comprising a first side 304 and a second side 404, a first or leading edge 306 and a second or trialing edge 308. A focal line 324 may be disposed about 1.500 inches from the first edge 306. As described herein, a spring strip 410 may be disposed over the fold line 324 along the second side 404 to reduce print errors, such as those due to gross off-set registration.

The second side 404 may include the spring strip 410 adhered to a portion of the second side via an adhesive 414. As described herein, the spring strip 410 may be adhered to the second side 410 proximal a leading-edge side of the focal line 324 and may be free of adhesive proximal a trail-edge side of the fold line 324. This may allow the spring strip 410 to pass freely over the focal line 324. It is noted, however, that the spring strip 410 may be adhered over the focal line 324, proximal the trailing edge side, or otherwise attached to the body 302. Here, both the adhesive 414 and the spring strip 410 extend from the side edges of the sheet 300 but are spaced from the first edge 306. The adhesive 414 may have a rectangular shape and the spring strip 410 may have a rectangular shape having a greater width dimension than that adhesive 414.

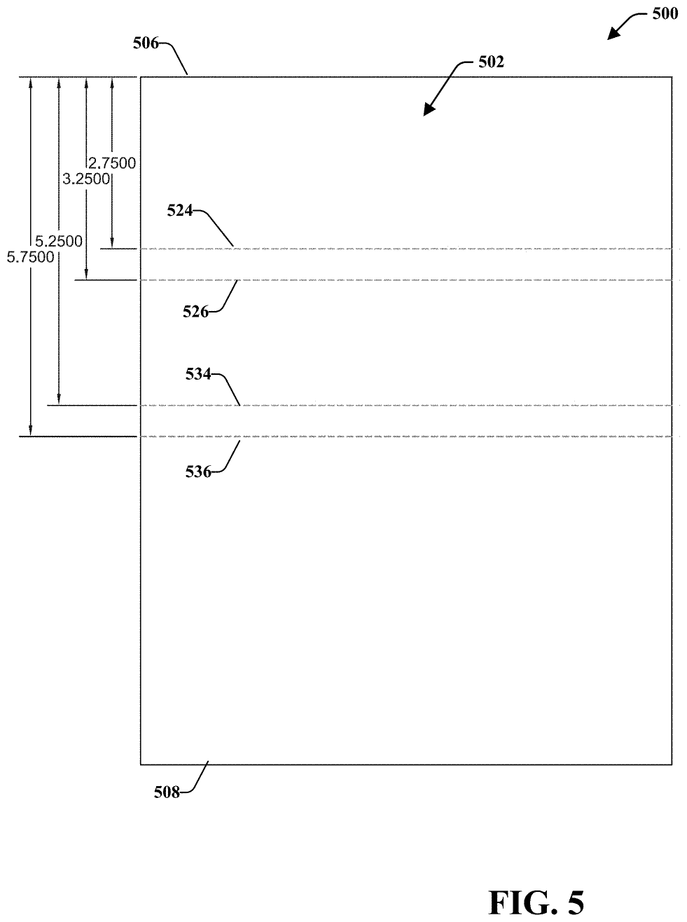

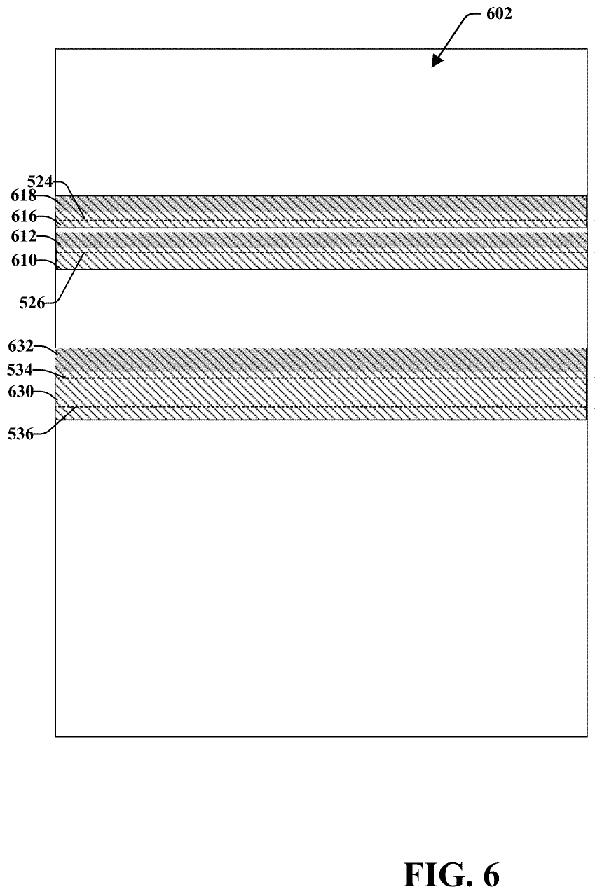

FIGS. 5-6 illustrate a sheet assembly 500 comprising body 502 comprising a first side 504 and a second side 604, a first or leading edge 506 and a second or trialing edge 508. The body 502 may comprise a number of focal lines, such as focal lines 524, 526, 534, and 536.

In an exemplary embodiment, the focal line 524 may be about 2.75 inches from the first edge 506, focal line 526 may be about 3.25 inches from the first edge 506, focal line 534 may be about 5.25 inches from the first edge 506, and focal line 536 may be about 5.75 inches from the first edge 506. It is noted that the above measurements are provided as an example. Other embodiments may include focal lines at different locations. In another aspect, other embodiments may include different numbers of fold lines. These focal lines may be in addition to various other fold lines or perforation lines along the sheet. The embodiments described herein illustrate a particular location of such focal lines in relation to the first edge in which the addition of spring strip has been particularly found to reduce off-registration when printing a plurality of sheet assemblies from a stacked orientation.

The first side 504 of body 502 may operatively receive indicia during a printing operation. The second side 604 may comprise a plurality of spring strips that operatively increase the resilience of the focal lines during processing through printer rollers. In an aspect, at least one spring strip may abut or cover each of focal lines 524, 526, 534, and 534. Shown in FIG. 6 are two constructions for providing a spring strip over the focal lines 524, 526, 534, and 534.

In an example, spring strip 616 may be adhered to the body 502 via adhesive 618 such that a portion of spring strip 616 reinforces the focal line 524. As shown, the leading-edge side of the spring strip 616 is adhered to the body 502. The spring strip 616 is allowed to pass freely over the focal line 524 and is not adhered on the trailing edge side. Spring strip 610 is similarly adhered via adhesive 612 such that it provides a resilient strip for the focal line 526.

In another example, a single spring strip 630 may span or cover one or more focal lines, such as focal lines 534 and 536. The spring strip 630 may be adhered to the body 602 via an adhesive 632 at a leading-edge side of the focal line 534. A portion of the spring strip 630 may freely overlay the focal lines 534 and 536. The spring strip 630 acts like a spring to reduce or prevent the focal lines 534 and 536 from creasing, tearing, or becoming otherwise damaged during printing resulting in improved print registration.

It is noted that each of the focal lines 524, 526, 534, and 534 may be associated with a single spring strip, may share spring strips with other fold lines, or the like. Moreover, spring strips 616, 610, and 630 may comprise similar or different materials. Various embodiments may include spring strips arranged differently in accordance with aspects disclosed herein.

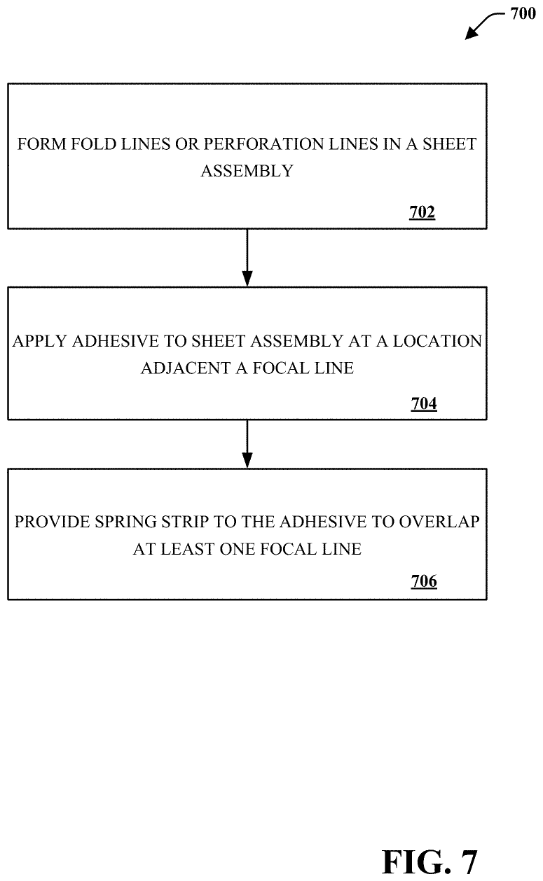

In view of the subject matter described herein, methods that may be related to various embodiments may be better appreciated with reference to the flowchart of FIG. 7. While the method is shown and described as a series of blocks, it is noted that associated methods or processes are not limited by the order of the blocks unless context suggests otherwise or warrants a particular order. It is further noted that some blocks and corresponding actions may occur in different orders or concurrently with other blocks. Moreover, different blocks or actions may be utilized to implement the methods described hereinafter. Various actions may be completed by one or more of users, mechanical machines, automated assembly machines (e.g., including one or more processors or computing devices), or the like.

FIG. 7 is a flow chart of an exemplary method 700 of forming a printable sheet assembly as described herein. The method 700 may be utilized to form one or more printable sheet assemblies that generally reduce or eliminate gross off-registration of cardstock in printers, such as in desktop or inkjet printers. More particularly, the method 700 may be utilized to form printable sheet assemblies with spring strips that provide resilience for fold lines.

At 702, a system or device may form fold lines, perforation lines, or cut lines on a printable sheet assembly. In an aspect, the fold lines may be formed at various positions on the sheet assembly. It is noted that the fold lines, perforation lines or cut lines may define a card product, such as a name tag or an adhesive label product that is pealed from a liner sheet. The printable sheet assembly may comprise cardstock as described herein. According to embodiments, the fold lines may include one or more fold lines formed in or at a focal region.

At 704, the system or device may apply an adhesive to a sheet assembly. The adhesive may be applied at a leading-edge side of at least one focal line as described herein. It is noted that various types of adhesives may be utilized.

At 706, the system or device may provide a spring strip to the focal lines. In an aspect, the spring strip may be adhered via the adhesive such that the spring strip is adhered at a leading-edge and passes freely over the focal fold line. A portion of the spring strip may extend past the fold line without being adhered to the sheet assembly. It is noted that the adhesive applied at 704 may be applied to the spring strip or the sheet assembly. Thus, the adhesive is disposed between the sheet body and the spring strip.

The particular location of the focal line may be determined as per the embodiments described about such as in FIG. 1-5. The focal line may be a fold line, perforation line, and/or cut line of a printable sheet assembly that is located along the sheet at a focal areas that is susceptible to causing off-registration when a plurality of sheets are processed through a printer. These focal areas are adjacent to the focal lines of FIGS. 1-5 and the location of focal lines in these areas in addition with the spring strip has been found to reduce and or prevent off-registration errors or otherwise processing errors of a plurality of sheet assemblies through a printer device.

The sheet assembly may comprise a cardstock or facestock having a label, nametag, or other product in or on the sheet assembly. Accordingly, the fold lines or perforations may be formed in the sheet to define the card product. As an example, a system may die cut nametags in the facestock of the sheet assembly. It is noted that the formation of the product may utilize the perforated lines as an edge of the label, nametag, or other product. In other examples, the perforated lines may not form an edge of a product. As described herein, the formation of the perforated lines and the product may occur in various orders or generally simultaneously.

Moreover, method 700 may include other or additional steps. For instance, the system or device may print indicia on packaging or the sheet assembly that identifies applicable printer devices for the sheet assembly. Different printers may comprise differently arranged rollers, feed angles, or the like. As such, perforated lines and/or fold lines may be associated with different printers. Thus, the system or device may identify associated printers to enhance an end user's experience.

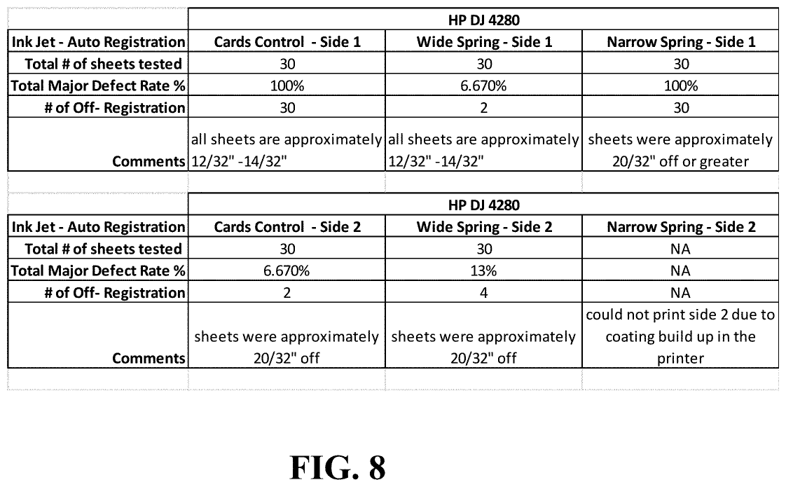

FIG. 8 illustrates a table with a summary of findings when utilizing a type of printer device to process printable sheet assemblies having focal lines thereon with and without the spring strip. Column 1 illustrates the test data related to a plurality of printable sheet assemblies without a spring strip. Column 2 illustrates the test data related to a plurality of printable sheet assemblies with a wide spring strip design. Column 3 illustrates the test data related to a plurality of printable sheet assemblies with a narrow spring strip design. The test comprised of processing 2 sets of 30 sheet stacks being printed on both sides of the sheet. A HP DJ 4280 Ink Jet Printer was used which is a U-turn type of printer device. Based on the test, the wide spring design provided the most improvement to off-registration issues.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The features of each embodiment described and shown herein may be combined with the features of the other embodiments described herein. The claims as follows are intended to include all modifications and alterations insofar as they come within the scope of the claims or the equivalent thereof.

What is claimed is:

1. A printable sheet assembly comprising:
a sheet body having a first side and a second side that includes a first edge and an opposite second edge, a first side edge and a second side edge, wherein the first edge is a configured to be fed into a printer device to print indicia along the first side.
said body including at least one focal line formed therein that extends between the first side edge and the second side edge; and
a first spring strip comprising a resilient material and disposed over the at least one focal line, wherein the first spring strip is at least partially adhered to the second side.

2. The printable sheet assembly according to claim 1, wherein the first spring strip is adhered to the second side of the sheet body at a leading-edge side of the first fold line and is not adhered to the cardstock at the trailing-edge side of the first fold line.

3. The printable sheet assembly according to claim 2, wherein the first spring strip freely overlays the first focal line.

4. The printable sheet assembly according to claim 1, further comprising a second focal line and second spring strip positioned over the second focal line.

5. The printable sheet assembly according to claim 4, wherein the second spring strip freely overlays the second fold line.

6. The printable sheet assembly according to claim 1, wherein the sheet body comprises at least one of a nametag, card, label or display product formed therein.

7. The printable sheet assembly according to claim 1, wherein the first spring strip comprises at least one of a polymer and a paper based material.

8. The printable sheet assembly according to claim 1 further comprising a strip of adhesive that is attached to the second side of the body sheet adjacent to the focal line, said adhesive extends generally parallel to and spaced from the focal line from the first side edge to the second side edge wherein the first spring strip is partially attached to the adhesive and freely overlays the focal line.

9. A printable sheet assembly comprising:
a sheet body comprising a first side and a second side and including a first edge and an opposite second edge wherein the first edge is configured to be inserted into a printer device to receive indicia along said first side;
at least one focal line formed in the sheet body, wherein the at least one focal line is operatively creaseable; and
at least one spring strip disposed on the second side of the sheet body and overlaying the at least one fold line, wherein the at least one spring strip operatively acts as a spring for the at least one fold line during a printing operation.

10. The printable sheet assembly of claim 9 wherein the at least one focal line is at or within about 0.5 inches from the first edge.

11. The printable sheet assembly of claim 9 wherein the at least one spring strip extends along the first edge of the sheet body.

12. The printable sheet assembly of claim 9 wherein the at least one focal line is at or within about 1.5 inches from the first edge of the sheet body.

13. The printable sheet assembly of claim 9 wherein the at least one spring strip is spaced from and generally parallel to the first edge of the sheet body.

14. The printable sheet assembly of claim 13 further comprising a plurality of focal lines and a plurality of spring strips.

15. The printable sheet assembly of claim 9 wherein the stock material includes two focal lines in generally parallel relationship to one another wherein the spring strip extends along the sheet body and overlays the two focal lines.

16. A method of making a printable sheet assembly, the method comprising:
providing sheet body having a first side configured to receive indicia from a printer device and an opposite second side and including a first edge and an opposite second edge and a first side edge and a second opposite side edge;
forming at least one focal line along the sheet body that extends from the first side edge to the second side edge;
applying adhesive to the second side of the sheet assembly at a location adjacent to the focal line; and
adhering a resilient strip to the sheet body that extends from the first side edge to the second side edge such that it overlays the at least one of the focal line.

17. The method of claim 16, wherein the resilient strip passes freely over the at least one focal line.

18. The method of claim 16 wherein the at least one focal line is at or within about 0.5 inches from the first edge.

19. The method of claim 16 wherein the at least one spring strip extends along the first edge of the sheet body.

20. The method of claim 16 wherein the at least one focal line is at or within about 1.5 inches from the first edge of the sheet body.
